(19) United States
(12) Patent Application Publication
(10) Pub. No.: US 2020/0250691 A1
(43) Pub. Date: Aug. 6, 2020

(54) INFORMATION PROCESSING APPARATUS, CONTROL METHOD, AND PROGRAM

(71) Applicant: NEC CORPORATION, Tokyo (JP)

(72) Inventors: So YAMADA, Tokyo (JP); Yousuke MOTOHASHI, Tokyo (JP); Norihito GOTO, Tokyo (JP); Ryo TAKATA, Tokyo (JP); Tomoko NARUSAKA, Tokyo (JP); Hiroki NAKATANI, Tokyo (JP)

(73) Assignee: NEC CORPORATION, Tokyo (JP)

(21) Appl. No.: 16/651,793

(22) PCT Filed: Sep. 25, 2018
(86) PCT No.: PCT/JP2018/035397

§ 371 Date: Mar. 27, 2020

(30) Foreign Application Priority Data
Sep. 29, 2017 (JP) 2017-190306

(51) Int. Cl. G06Q 30/02; G06F 17/18

(52) U.S. Cl. CPC G06Q 30/0204; G06F 17/18; G06Q 30/0201

(57) ABSTRACT

An information processing apparatus according to the present invention divides a period in which performance data at a business facility as a prediction target is present into a plurality of partial periods. The information processing apparatus performs prediction processing using each of a plurality of prediction models for a second partial period which is a partial period other than a first partial period including a start time of a predetermined period, and compares the result of the process with the performance data in a partial period as a target of the prediction processing. The information processing apparatus decides a prediction model to be used for sales prediction for a period subsequent to the predetermined period on the basis of the result of the comparison.

### TECHNICAL FIELD

The present invention relates to an information processing apparatus, a control method, and a program.

### BACKGROUND ART

A store such as a convenience store needs to order an appropriate quantity of products by predicting a quantity demanded for each product from the past sales performance of the product in order to prevent products from being sold out and unsold products from being disposed. However, in a case where the sales performance is not sufficiently accumulated (for example, a case where a demanded product quantity is predicted at a new store immediately after the new store is opened), there are many cases where sufficient prediction accuracy is not obtained by a statistical method of deciding variables or weights of the prediction model by simply using data of the sales performance.

For example, there are technologies disclosed in Patent Document 1 and Patent Document 2 as the technology for predicting the demanded product quantity. Patent Document 1 discloses the technology for generating a model for predicting a demanded quantity of a new product by using sales performance of similar products. Patent Document 2 discloses the technology for allowing a user to visually select a prediction model appropriate for fluctuations in past demanded quantity by displaying a graph representing the fluctuations in past demanded quantity and a prediction model manually selected by the user side by side.

### RELATED DOCUMENT

### Patent Document

[Patent Document 1] Japanese Patent Application Publication No. 2017-27632

[Patent Document 2] Japanese Patent Application Publication No. 2003-346070

### SUMMARY OF THE INVENTION

### Technical Problem

The present inventors have found a new technology for deciding a prediction model to be used for predicting a sales amount and the number of customers at a business facility such as a store. An object of the present invention is to provide a new technology for deciding a prediction model to be used for predicting a sales amount and the number of customers at a business facility such as a store.

### Solution to Problem

A first information processing apparatus according to the present invention includes 1) a dividing unit that divides a performance period in which performance data at a business facility as a prediction target is present into a plurality of partial periods, 2) a comparing unit that performs prediction processing using each of a plurality of prediction models for a second partial period which is a partial period other than a first partial period including a start time of the performance period, and compares the result of the process with the performance data in a partial period as a target of the prediction processing, and 3) a first deciding unit that decides a prediction model to be used for sales prediction of a period subsequent to the performance period on the basis of the result of the comparison performed by the comparing unit.

A second information processing apparatus according to the present invention includes 1) a dividing unit that divides a performance period in which performance data of a customer-prediction target is present into a plurality of partial periods, 2) a comparing unit that performs prediction processing using each of a plurality of prediction models for a second partial period which is a partial period other than a first partial period including a start time of the performance period, and compares the result of the process with the performance data in a partial period as a target of the prediction processing, and 3) a first deciding unit that decides a prediction model to be used for customer prediction of a period subsequent to the performance period on the basis of the result of the comparison performed by the comparing unit.

A first program according to the present invention causes a computer to execute 1) a dividing step of dividing a performance period in which performance data at a business facility as a prediction target is present into a plurality of partial periods, 2) a comparing step of performing prediction processing using each of a plurality of prediction models for a second partial period which is a partial period other than a first partial period including a start time of the performance period, and compares the result of the process with the performance data in a partial period as a target of the prediction processing, and 3) a first deciding step of deciding a prediction model to be used for sales prediction of a period subsequent to the performance period on the basis of the result of the comparison performed in the comparing step.

A second program according to the present invention causes a computer to execute 1) a dividing step of dividing a performance period in which performance data of a customer-prediction target is present into a plurality of partial periods, 2) a comparing step of performing prediction processing using each of a plurality of prediction models for a second partial period which is a partial period other than a first partial period including a start time of the performance period, and compares the result of the process with the performance data in a partial period as a target of the prediction processing, and 3) a first deciding step of deciding a prediction model to be used for customer prediction of a period subsequent to the performance period on the basis of the result of the comparison performed in the comparing step.

A first control method according to the present invention is executed by a computer. The control method includes 1) a dividing step of dividing a performance period in which performance data at a business facility as a prediction target is present into a plurality of partial periods, 2) a comparing step of performing prediction processing using each of a plurality of prediction models for a second partial period which is a partial period other than a first partial period including a start time of the performance period, and compares the result of the process with the performance data in a partial period as a target of the prediction processing, and 3) a first deciding step of deciding a prediction model to be used for sales prediction of a period subsequent to the performance period on the basis of the result of the comparison performed in the comparing step.

A second control method according to the present invention is executed by a computer. The control method includes 1) a dividing step of dividing a performance period in which performance data of a customer-prediction target is present into a plurality of partial periods, 2) a comparing step of performing prediction processing using each of a plurality of prediction models for a second partial period which is a partial period other than a first partial period including a start time of the performance period, and compares the result of the process with the performance data in a partial period as a target of the prediction processing, and 3) a first deciding step of deciding a prediction model to be used for customer prediction of a period subsequent to the performance period on the basis of the result of the comparison performed in the comparing step.

### Advantageous Effects of Invention

According to the present invention, a new technology for deciding a prediction model to be used for predicting a sales amount and the number of customers at a business facility such as a store is provided.

### BRIEF DESCRIPTION OF THE DRAWINGS

The aforementioned object and other objects, features, and advantages will be further apparent by preferred example embodiments to be described below and the following drawings attached thereto.

FIG. 1 illustrates a diagram for describing an outline of an information processing apparatus according to Example Embodiment 1.

FIG. 2 is a diagram illustrating an outline of the information processing apparatus according to Example Embodiment 1.

FIG. 3 is a diagram illustrating a functional configuration of the information processing apparatus according to Example Embodiment 1.

FIG. 4 is a diagram illustrating a computer that realizes the information processing apparatus.

FIG. 5 is a flowchart illustrating a flow of a process executed by the information processing apparatus according to Example Embodiment 1.

FIG. 6 is a diagram illustrating targets of sales prediction.

FIG. 7 is a diagram illustrating a configuration of a database in which a prediction model is stored.

FIG. 8 is a diagram illustrating a scene in which a length of a first partial period is specified by a user of the information processing apparatus.

FIG. 9 is a diagram illustrating data output by a first deciding unit.

FIG. 10 is a diagram illustrating a scene in which future sales predicted by the prediction model are visualized.

FIG. 11 is a diagram illustrating an operation of an information processing apparatus according to Example Embodiment 2.

FIG. 12 is a flowchart illustrating a flow of a process executed by the information processing apparatus according to Example Embodiment 2.

FIG. 13 is a diagram illustrating a case where a performance period is divided into three partial periods.

FIG. 14 is a diagram illustrating a relationship between the performance period and each partial period.

FIG. 15 is a diagram illustrating a functional configuration of an information processing apparatus according to Example Embodiment 3.

FIG. 16 is a flowchart illustrating a flow of a process performed by the information processing apparatus according to Example Embodiment 3.

FIG. 17 is a diagram illustrating a case where the first deciding unit is used at a predetermined frequency in a table.

FIG. 18 is a diagram illustrating an operation of an information processing apparatus according to Example Embodiment 4.

FIG. 19 is a diagram illustrating a functional configuration of the information processing apparatus according to Example Embodiment 4.

FIG. 20 is a flowchart illustrating a flow of a process executed by the information processing apparatus according to Example Embodiment 4.

### DESCRIPTION OF EXAMPLE EMBODIMENTS

Hereinafter, example embodiments according to the present invention will be described with reference to the drawings. In all the drawings, the same reference signs are given to the same components, and the description will not be appropriately repeated. Unless otherwise specified, in each block diagram, each block represents not a configuration of a hardware unit but a configuration of a functional unit.

### Example Embodiment 1

<Outline>

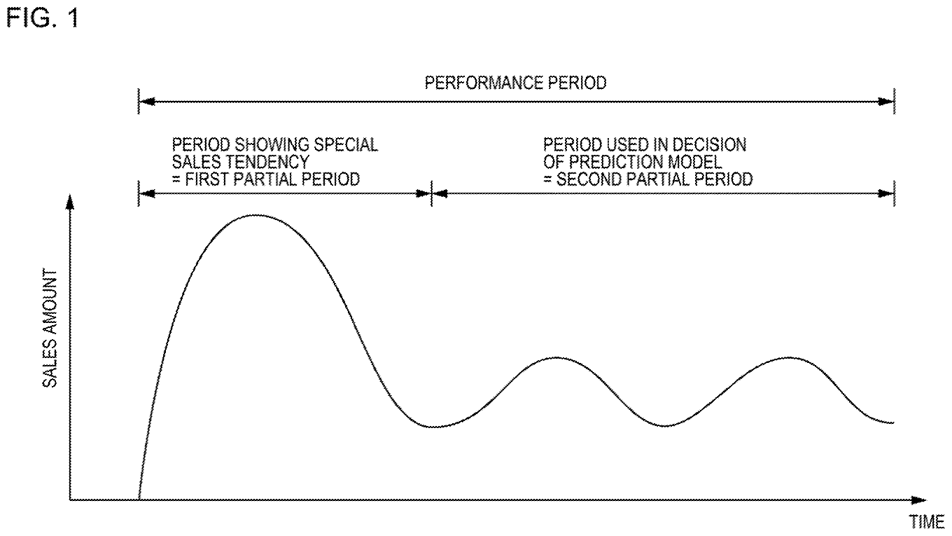

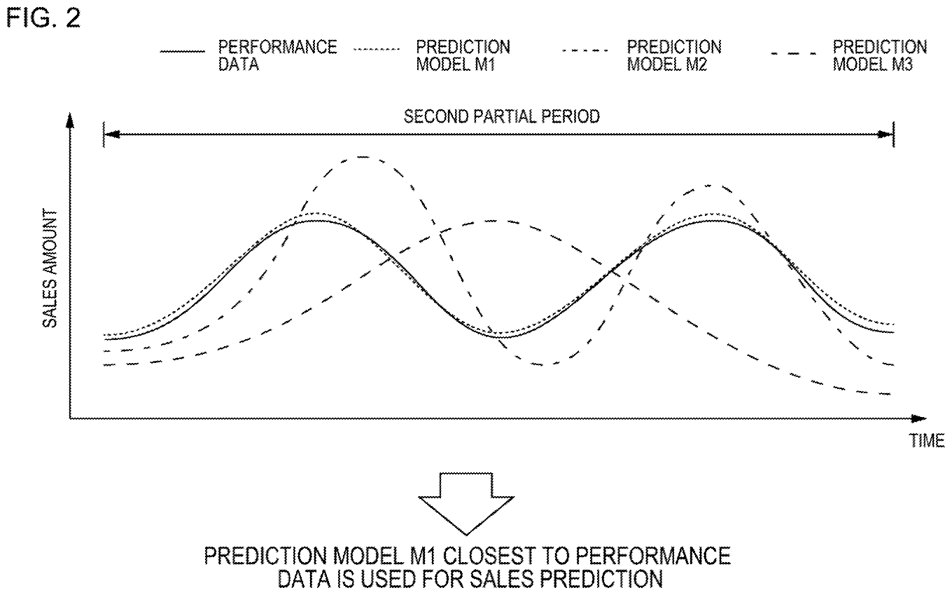

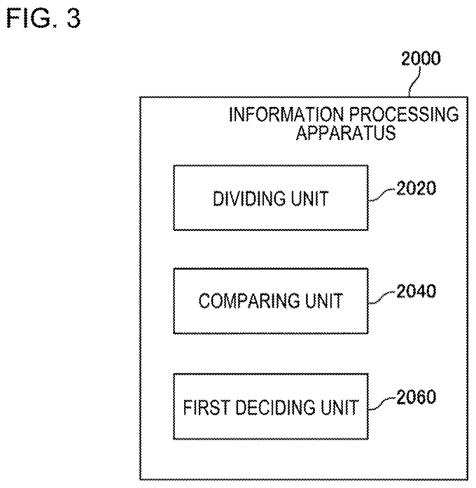

FIGS. 1 and 2 are diagrams for describing an outline of an information processing apparatus (an information processing apparatus 2000 illustrated in FIG. 3) according to Example Embodiment 1. An operation of the information processing apparatus 2000 to be described below is an example for facilitating the understanding of the information processing apparatus 2000, and the operation of the information processing apparatus 2000 is not limited to the following example. Details and variations of the operation of the information processing apparatus 2000 will be described below.

The information processing apparatus 2000 decides a prediction model appropriate for subsequent sales prediction at a business facility as a prediction target by using data of sales performance at the business facility. The business facility is, for example, a store such as a convenience store. For example, some time after a new business facility (including a reopened business facility) is opened (for example, several weeks later), the information processing apparatus 2000 decides a prediction model to be used for sales prediction of the new business facility by using data of sales performance obtained so far. Hereinafter, the business facility as the prediction target is also referred to as a “target business facility”. The data of the sales performance is also referred to as “performance data”.

The information processing apparatus 2000 causes each of a plurality of prediction models to execute prediction processing for predicting sales for a period in which the performance data of the target business facility is present. The information processing apparatus 2000 determines a prediction model of which a prediction result is most appropriate for actual sales by comparing data (hereinafter, prediction data) representing the result of the prediction processing with sales performance data.

Here, the performance data at the newly opened business facility may include data indicating a special sales tendency different from a sales tendency during usual business hours such as sales data during an opening sales period. For example, in a graph of FIG. 1, sales performance represented by a first mountain portion is significantly different from the subsequent sales performance. In a case where performance data of such a special tendency is used for selecting a prediction model, it is difficult to appropriately select a prediction model that predicts a sales tendency in a normal period.

Therefore, the information processing apparatus 2000 divides a period (hereinafter, a performance period) in which sales performance is obtained into a plurality of partial periods. The information processing apparatus 2000 uses a second partial period which is a partial period other than a first partial period including a start time of the performance period among the plurality of partial periods for evaluating the prediction model. For example, in FIG. 1, the performance period is divided into two of the first partial period and the second partial period.

The information processing apparatus 2000 performs sales prediction processing for the second partial period by using each of the plurality of prediction models. For example, sales on a specific date may be predicted by using variables such as weather and day of the week. The prediction models are different depending on variables to be used and values of the weights of the variables.

The information processing apparatus 2000 compares prediction data obtained as a result of the prediction processing using each prediction model with performance data of the second partial period. The information processing apparatus 2000 decides a prediction model to be used for sales prediction after the performance period on the basis of this comparison. For example, the information processing apparatus 2000 uses a prediction model of which the prediction data is closest to the sales performance in the second partial period for sales prediction after the performance period.

FIG. 2 is a diagram illustrating a scene in which the prediction model to be used for the sales prediction is decided by using the plurality of prediction models. FIG. 2 illustrates the performance data and the prediction data generated by each prediction model for the second partial period. In this example, it can be said that prediction data generated by a prediction model M1 is closest to the performance data. Thus, the information processing apparatus 2000 decides, as the prediction model M1, the prediction model to be used for the sales prediction. However, as will be described below, the method of deciding the prediction model to be used for the sales prediction is not limited to a method of selecting the prediction model that generates the prediction data closest to the performance data.

<Actions and Effects>

In accordance with the information processing apparatus 2000 according to the present example embodiment, the prediction using each of the plurality of prediction models is compared with the sales performance for a period (second partial period) obtained by excluding a partial period from the performance period in which the sales performance is present. The prediction model to be used for the sales prediction is decided on the basis of the result of this comparison. As stated above, prediction accuracy of each prediction model can be more accurately evaluated by excluding a period showing a special sales tendency from a period used for evaluating appropriateness of the prediction model. As a result, since it is possible to select the prediction model that can accurately predict the sales of the business facility such as a new store, future sales at the business facility can be predicted with high accuracy.

Hereinafter, the information processing apparatus 2000 according to the present example embodiment will be described in more detail.

<Example of Functional Configuration of Information Processing Apparatus 2000>

FIG. 3 is a diagram illustrating a functional configuration of the information processing apparatus 2000 according to Example Embodiment 1. The information processing apparatus 2000 includes a dividing unit 2020, a comparing unit 2040, and a first deciding unit 2060. The dividing unit 2020 divides the performance period in which the performance data of the target business facility is present into the plurality of partial periods. Here, the plurality of partial periods includes the first partial period and the second partial period. The first partial period includes the start time of the performance period. The comparing unit 2040 performs the prediction processing for each of the plurality of prediction models for the second partial period. The comparing unit 2040 compares the prediction data obtained as the result of each prediction processing with the performance data of the second partial period. The first deciding unit 2060 decides the prediction model to be used for the sales prediction in the target business facility after the performance period on the basis of the comparison result of the prediction data with the performance data.

<Hardware Configuration of Information Processing Apparatus 2000>

Each functional component of the information processing apparatus 2000 may be realized by hardware (for example: hard-wired electronic circuit) that realizes each functional component, or may be realized by a combination of hardware and software (for example: a combination of an electronic circuit and a program for controlling the electronic circuit). Hereinafter, a case where each functional component of the information processing apparatus 2000 is realized by a combination of hardware and software will be further described.

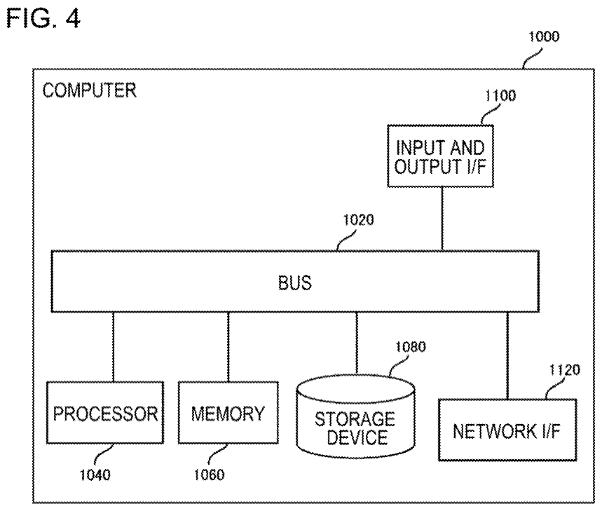

FIG. 4 is a diagram illustrating a computer 1000 for realizing the information processing apparatus 2000. The computer 1000 is any computer. For example, the computer 1000 is a personal computer (PC), a server machine, a tablet terminal, or a smartphone. The computer 1000 may be a dedicated computer designed for realizing the information processing apparatus 2000 or a general-purpose computer.

The computer 1000 includes a bus 1020, a processor 1040, a memory 1060, a storage device 1080, an input and output interface 1100, and a network interface 1120. The bus 1020 is a data transmission path through which the processor 1040, the memory 1060, the storage device 1080, the input and output interface 1100, and the network interface 1120 transmit and receive data to and from each other. However, the method of connecting the processor 1040 and the like to each other is not limited to the bus connection. The processor 1040 is various processors such as a central processing unit (CPU), a graphics processing unit (GPU), or a field-programmable gate array (FPGA). The memory 1060 is a main storage device configured by using a random access memory (RAM) or the like. The storage device 1080 is an auxiliary storage device configured by using a hard disk, a solid state drive (SSD), a memory card, a read only memory (ROM), or the like.

The input and output interface 1100 is an interface for connecting the computer 1000 and input and output devices. For example, the input device such as a keyboard and the output device such as a display device are connected to the input and output interface 1100.

The network interface 1120 is an interface for connecting the computer 1000 to a network. This communication network is, for example, a local area network (LAN) or a wide area network (WAN). The method by which the network interface 1120 connects the computer to the network may be a wireless connection or a wired connection.

The storage device 1080 stores a program module that implements each functional component of the information processing apparatus 2000. The processor 1040 realizes a function corresponding to each program module by reading each program module into the memory 1060 and executing the program module.

<Flow of Process>

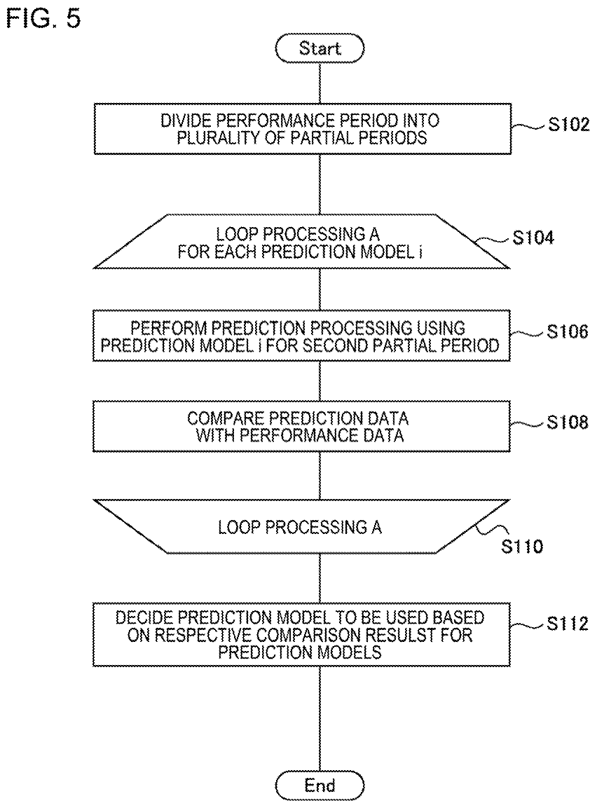

FIG. 5 is a flowchart illustrating a flow of a process executed by the information processing apparatus 2000 according to Example Embodiment 1. The dividing unit 2020 divides the performance period into the plurality of partial periods (S102). S104 to S110 are loop processing executed for each of the plurality of prediction models. In S104, the information processing apparatus 2000 judges whether or not loop processing A is already executed on all the prediction models. In a case where the loop processing A is already executed on all the prediction models, the process of FIG. 5 proceeds to S212. On the other hand, in a case where there are the prediction models on which the loop processing A is not performed yet, the information processing apparatus 2000 executes the loop processing A on one of these prediction models. Here, the prediction model on which the loop processing A is performed is referred to as a prediction model i.

The comparing unit 2040 performs the prediction processing using the prediction model i for the second partial period (S106). The comparing unit 2040 compares the prediction result (the prediction data obtained by the prediction processing) with the performance data (S108). Since S110 is the end of the loop processing A, the processing of FIG. 5 proceeds to S104.

After the loop processing A is completed, the first deciding unit 2060 decides the prediction model to be used for the sales prediction on the basis of the comparison result of the prediction result of each prediction model with the performance data (S112).

Here, a trigger for executing the series of processing illustrated in FIG. 5, that is, a trigger for using the information processing apparatus 2000 is optional. For example, the information processing apparatus 2000 executes the series of processing illustrated in FIG. 5 in response to receiving a predetermined input operation from a user of the information processing apparatus 2000. For example, the information processing apparatus 2000 executes the series of processing illustrated in FIG. 5 at a predetermined cycle. For example, there is a usage method of operating the information processing apparatus 2000 once a day before the business facility starts business to decide a prediction model to be used for sales prediction of the day.

<About Target Business Facility>

The business facility as the prediction target may be any facility where products are sold. For example, the business facility is any store such as a convenience store, a supermarket, a shopping mall, or a department store. The store mentioned herein refers to any sales space where products are sold, and is not necessarily limited to the sales space provided in a building. For example, in a case where the product or the like are sold in a temporary space provided outdoors, the temporary space corresponds to a store.

For example, the business facility may be a sales space (such as a store) provided in a facility (such as a restaurant, a stadium, a museum, or a theme park) where services are mainly provided.

Here, in a large-scale business facility, there are cases where the inside thereof is divided into a plurality of sections. In this case, the sales prediction may be performed for each of the plurality of sections, or may be performed for the entire business facility. In the former case, each of the plurality of sections is handled as an individual target business facility.

<About Usage Scene of Information Processing Apparatus 2000>

A scene in which the information processing apparatus 2000 is used is not limited to the decision of the prediction model used for the sales prediction of the newly opened business facility described above. For example, for a newly released product, some time after the newly released product is started to be sold at the target business facility, the information processing apparatus 2000 decides a prediction model to be used for sales prediction of the newly released product at the target business facility by using sales performance of the newly released product obtained so far.

For example, the information processing apparatus 2000 decides the prediction model by using, as the target business facility, the business facility at which the prediction model to be used for the sales prediction needs to be changed due to a significant change in sales tendency. Specifically, some time after the sales tendency is changed at the target business facility, the information processing apparatus 2000 decides a prediction model to be newly used at the target business facility by using sales performance after the sales tendency is changed at the target business facility.

<About Product or the Like as Target of Sales Prediction>

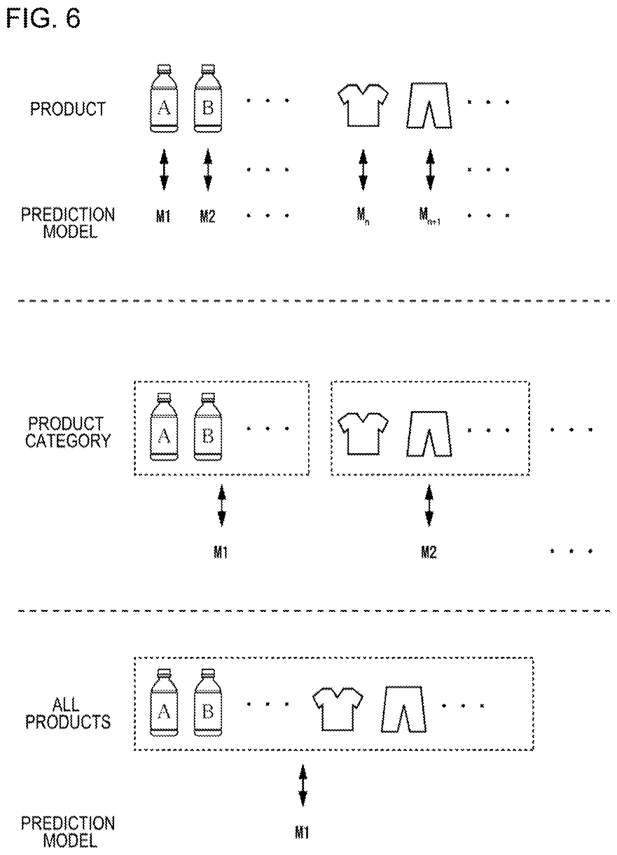

The prediction model is used for predicting sales of a product or the like. Here, various items can be adopted as the “product or the like” which is the target of the sales prediction. FIG. 6 is a diagram illustrating targets of the sales prediction. In an example of an upper part of FIG. 6, the target of the sales prediction is a certain specific product. In this case, the prediction model is decided for each product. For example, in a case where the business facility as the prediction target handles 1000 kinds of products, the prediction model is decided for each of these 1000 kinds of products. However, it is not always necessary to decide the prediction model for all the products handled at the business facility as the prediction target. The products are distinguished, for example, on the basis of product names. For example, the products may be distinguished on the basis of a so-called stock keeping unit (SKU).

In an example of a middle part of FIG. 6, the target of the sales prediction is a group of products belonging to a certain specific category. In this case, the prediction model is decided for each product category. For example, in a case where products being sold at the business facility as the prediction target are classified into 100 product categories, the prediction model is decided for each of the 100 product categories. However, it is not always necessary to decide the prediction model for all the product categories handled at the business facility as the prediction target.

Here, an existing method may be used as the method of classifying the products into the categories. For example, the product categories into which the products are relatively roughly classified such as groceries, clothing, and toys may be adopted. For example, the product categories into which the products are relatively finely classified such as classification of meat into pork, beef, and chicken may be adopted.

In an example of a lower part of FIG. 6, the target of the sales prediction is all the products being sold at the business facility as the prediction target. In this case, one prediction model is decided for one target business facility.

<About Performance Data>

The information processing apparatus 2000 acquires performance data representing sales performance of the product or the like at the target business facility for the product or the like as the target of the sales prediction. For example, in a case where the information processing apparatus 2000 decides a prediction model for a product X at a business facility A, sales performance data to be used is data representing sales performance of the product X at the business facility A.

Here, the performance period is not necessarily the entire period in which the sales performance of the target business facility is present, and is different depending on the usage scene of the information processing apparatus 2000. In a case where the newly opened business facility is set as the target business facility, the start time of the performance period is, for example, a date on which the target business facility is opened. In a case where the sales prediction of a new product at the target business facility is performed, the start time of the sales period is, for example, a date on which the new product is started to be sold at the target business facility. In a case where the business facility where the sales tendency of the product is changed is set as the target business facility, the performance period is, for example, a date on which the sales tendency is changed. It should be noted that, the date on which the sales tendency is changed may be specified by the user, or may be decided by the information processing apparatus 2000 by performing statistical processing on the performance data.

The performance data used by the information processing apparatus 2000 indicates the performance of the sales with the same granularity as the product or the like which is the target of the sales prediction. For example, in a case where the sales prediction is performed for each product, the sales performance data indicates the sales performance for each product. For example, in a case where the sales prediction is performed for each product category, the sales performance data indicates the sales performance for each product category. It should be noted that, in a case where the performance data represents the sales performance with a finer granularity than the prediction target (for example, in a case where the unit of the prediction target is the product category while the unit of the performance data is the product), the performance data is converted into the performance data representing the sales performance with the same granularity as the prediction target by processing the performance data in advance. The information processing apparatus 2000 uses the converted performance data.

There are various methods by which the information processing apparatus 2000 acquires the performance data. For example, the performance data may be stored in a storage device accessible from the information processing apparatus 2000 in advance. For example, the performance data may be stored in a database server that collects and manages the performance data from each of a plurality of business facilities. In this case, the information processing apparatus 2000 acquires the performance data by accessing the database server.

<About Prediction Model>

The prediction model outputs a predicted sales value on the basis of one or more variables. Various variables may be adopted as the variables used by the prediction model. For example, the variable is a sales amount for a predetermined period (for example, one week) closest to a prediction target date, weathers of the prediction target date and predetermined periods before and after the prediction target date, or attributes (day of the week, holidays, or notes) of the prediction target date and the predetermined periods before and after the prediction target date. Here, the sales amount means the number and weight of sold products. Examples of the products of which the sales amount is represented by the weight include fresh foods sold by weight.

The sales amount in the predetermined period closest to the prediction target date may be determined by using the performance data. The weathers of the prediction target date and the period before the prediction target date may be stored in advance in a storage device accessible from the information processing apparatus 2000, or may be acquired by using information provided from a server outside the information processing apparatus 2000. The weather of the period after the prediction target date may be determined by using, for example, a service (such as a web page) that provides a weather forecast. The attributes of the prediction target date and the predetermined periods before and after the prediction target date may be determined by using calendar information. The calendar information may be stored in a storage device accessible from the information processing apparatus 2000 in advance, or may be provided from a server outside the information processing apparatus 2000.

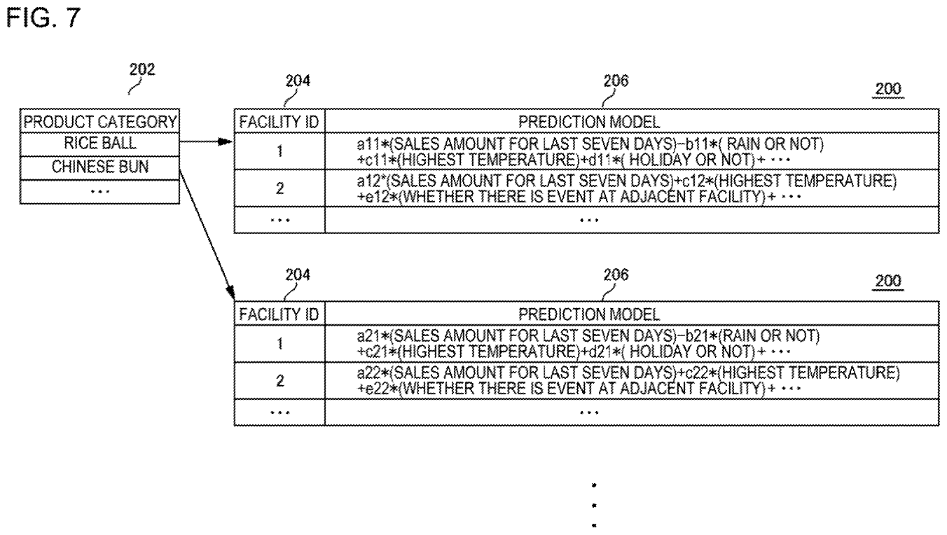

The method by which the information processing apparatus 2000 acquires the prediction model is optional. For example, the information processing apparatus 2000 acquires the prediction model from a database server in which the prediction model is stored. FIG. 7 is a diagram illustrating a configuration of a database in which the prediction model is stored. First, there is a product category 202 indicating a list of the product categories. A table 200 is associated with each product category represented in the product category 202. The table 200 associates a facility ID 204 with a prediction model 206.

The prediction model 206 is an example of the prediction model. An expression represented in the prediction model 206 is used for computing predicted sales by substituting a specific value for each variable. For example, the sales amount indicated by the performance data for the last seven days on which the sales are to be predicted is substituted for “sales amount for the last seven days”. 1 is substituted for “whether it is raining” in a case where the weather forecast of the date on which the sales are to be predicted is rain, and 0 is substituted otherwise. It should be noted that, all and the like are weights for variables.

In an example of FIG. 7, it is assumed that, in each of business facilities for which the sales performance is sufficiently accumulated, the prediction model that is generated based on the sales performance is used. That is, it is assumed that the target business facility uses the prediction model generated for another business facility. Thus, the facility ID which is an identifier of the business facility where the prediction model is generated is associated with the prediction model.

An existing technology may be used as a technology for generating the prediction model on the basis of the sales performance. For example, the prediction model may be generated by analyzing past sales performance by a statistical method such as regression analysis. Specifically, a method such as support vector machine (SVM), a decision tree, or deep learning may be used.

It should be noted that, the prediction model does not necessarily need to be generated for each business facility. For example, one prediction model may be generated by using the sales performance of the plurality of business facilities having a common attribute. The attribute mentioned herein includes, for example, an area and a location condition (a distance from a station, whether or not it is in an urban area, or whether or not there is a large event facility nearby). For example, since convenience stores near train stations are likely to have common features such as high sales during commuting hours only on weekdays, one prediction model may be generated by using the sales performance of a plurality of convenience stores near the stations.

The information processing apparatus 2000 acquires the prediction model corresponding to the product or the like as the prediction target. For example, in a case where the prediction model for the product X being sold at the target business facility is decided, the information processing apparatus 2000 acquires each prediction model for the product X.

Here, the information processing apparatus 2000 may acquire not all of the prediction models corresponding to the product or the like as the prediction target but only some of the prediction models. For example, the information processing apparatus 2000 may be configured to acquire only the prediction model generated for the business facility having the common attribute as the target business facility. For example, in a case where the target business facility is a facility in front of the station, the information processing apparatus 2000 acquires only the prediction model generated for each business facility in front of the station. For example, information such as the attribute of the business facility which is used for narrowing down the prediction models is stored in a database server together with the aforementioned prediction model.

<About Dividing Unit 2020: S102>

The dividing unit 2020 divides the performance period into the plurality of partial periods (S102). The plurality of partial periods generated by this division include at least the first partial period and the second partial period. The first partial period is a period that is not used for the prediction processing using the prediction model. On the other hand, the second partial period is a period that is used for the prediction processing using the prediction model.

<<Method of Deciding Performance Period>>

The performance period may be any period in which the performance data is present. For example, the dividing unit 2020 handles the entire period in which the performance data is present as the performance period. For example, the dividing unit 2020 may set, as the performance period, a period having a predetermined length (for example, one month) from the start time of the period in which the performance data is present. For example, the dividing unit 2020 may set, as the performance period, a period having a predetermined length specified by the user of the information processing apparatus 2000 from the start time of the period in which the performance data is present.

<<Method of Deciding Partial Period>>

The dividing unit 2020 divides the performance period into two of the first partial period and the second partial period. That is, the dividing unit 2020 divides the performance period into two with a certain date and time as a boundary, sets the performance period before the certain date and time as the first partial period, and sets the performance period after the certain date and time as the second partial period. It should be noted that, the date and time as the boundary may be included in any one of the first partial period and the second partial period.

Here, the method of deciding the date and time as the boundary between the first partial period and the second partial period is optional. For example, a length of the first partial period is decided in advance. In this case, the dividing unit 2020 generates the first partial period and the second partial period by dividing the performance period with a date and time at which a predetermined length elapses from the start time of the performance period. For example, the length of the first partial period is stored in a storage device accessible from the information processing apparatus 2000.

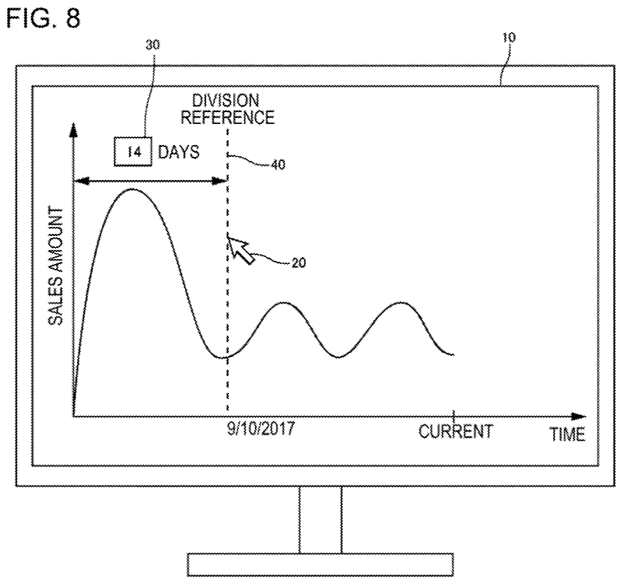

For example, the information processing apparatus 2000 receives an input operation for specifying the length of the first partial period from the user of the information processing apparatus 2000. FIG. 8 is a diagram illustrating a scene in which the length of the first partial period is specified by the user of the information processing apparatus 2000. A graph in which the performance data is visualized is drawn on a display screen 10 of FIG. 8. A reference line serving as a boundary between the first partial period and the second partial period is drawn.

For example, the user specifies the length of the first partial period by moving the reference line 40 to any position in a time axis direction by dragging the reference line 40 with a pointer 20. For example, the user specifies the length of the first partial period by inputting the length of the first partial period into a text box 30.

The length of the first partial period may be automatically decided by the dividing unit 2020. In this case, the dividing unit 2020 decides the length of the first partial period by using the performance data. The dividing unit 2020 computes an index (for example, a sales variance or a maximum absolute differential value) that quantitatively represents the magnitude of sales fluctuation for each predetermined unit such as one week. The dividing unit 2020 sets a point of time when the index satisfies a predetermined condition as an end time of the first partial period. For example, in a case where the index is computed on a weekly basis and the predetermined condition is satisfied in the third week (third unit) from the start time of the first partial period, the dividing unit 2020 sets, as the length of the first partial period, three weeks.

The predetermined condition may be fixedly set in advance, or may be specified by the user of the information processing apparatus 2000.

<Prediction Processing Using Prediction Model: S106>

The comparing unit 2040 executes the prediction processing using each prediction model for the second partial period (S106). Specifically, the comparing unit 2040 causes the prediction model to execute the prediction processing by applying a specific variable value obtained from the calendar information to the prediction model. It should be noted that, the variables used by the prediction model are as described above.

The prediction model outputs, as the result of the prediction processing, the prediction data of the second partial period (data representing sales predicted for the second partial period). For example, the prediction data is time-series data indicating the sales amount predicted for each date included in the second partial period. Here, the prediction granularity for a time axis is not limited to a day unit. For example, the prediction data may indicate a predicted sales amount for each of a plurality of time zones of one day. It should be noted that, it is desirable that the granularity of the prediction data on the time axis is the same as the granularity of the performance data on the time axis.

<Evaluation Using Comparing Unit 2040: S108>

The comparing unit 2040 compares the prediction data output from the prediction model with the performance data (S108). Specifically, the comparing unit 2040 computes an index value that quantitatively represents a degree of deviation between the prediction data and the performance data. Hereinafter, this index value is referred to as a deviation index value. For example, an average absolute error or an average square error may be used as the deviation index value.

<Decision of Prediction Model Using First Deciding Unit 2060: S112>

The first deciding unit 2060 decides the prediction model to be used for the sales prediction on the basis of the result of the comparison by the comparing unit 2040 (S112). Specifically, the first deciding unit 2060 determines the prediction model having the smallest deviation index value (the prediction model that outputs prediction data having the smallest degree of deviation from the performance data), and decides the determined prediction model as the prediction model to be used for the sales prediction.

For example, the first deciding unit 2060 may generate the prediction model to be used for the sales prediction by performing the statistical processing on the plurality of acquired prediction models based on the deviation index value. For example, the first deciding unit 2060 generates the prediction model to be used for the sales prediction by performing the statistical processing on the prediction models having a predetermined rank or higher in ascending order of the deviation index values among the acquired prediction models. This statistical processing is, for example, averaging. At this time, the first deciding unit 2060 may compute a weighted average obtained by assigning a weight (such as a reciprocal of the deviation index value or a value obtained by normalizing the reciprocal of the deviation index value) which becomes smaller as the deviation index value becomes larger to each prediction model.

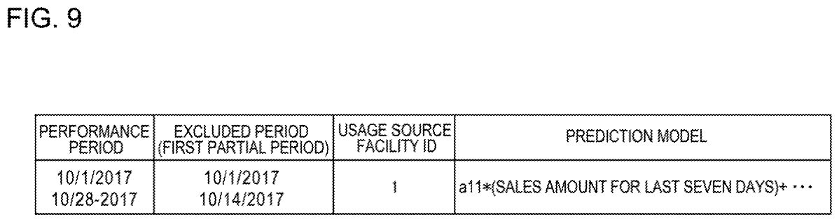

FIG. 9 is a diagram illustrating data output by the first deciding unit 2060. A table of FIG. 9 illustrates the performance period used for deciding the prediction model, the period (first partial period) excluded in the evaluation of the prediction model, the facility ID of a usage source of the prediction model, and the prediction model decided as the prediction model to be used for the sales prediction. It should be noted that, the “facility ID of the usage source of the prediction model” indicates the business facility where the prediction model decided to be used for the sales prediction is generated as the prediction model (facility ID 204 of FIG. 7).

<Usage Example of Decided Prediction Model>

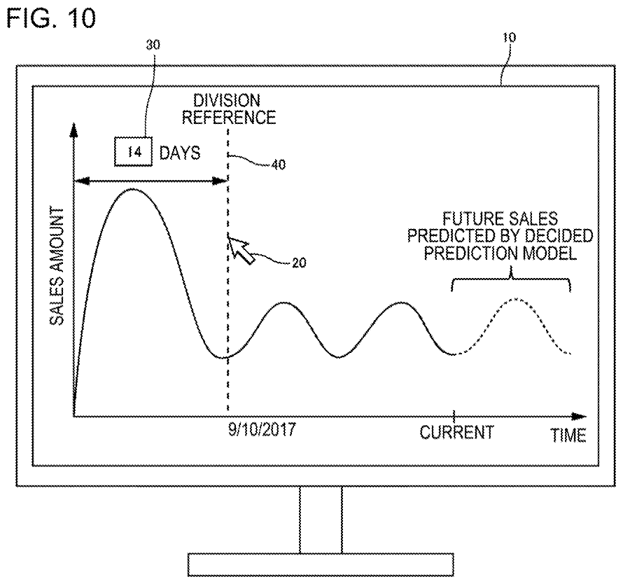

FIG. 10 is a diagram illustrating a scene in which future sales predicted by the prediction model are visualized. In FIG. 10, a solid line graph visualizes the performance data. On the other hand, a dotted-line graph visualizes the future sales predicted by using the prediction model decided by the first deciding unit 2060. It is desirable that the information processing apparatus 2000 predicts the future sales by using the decided prediction model and visualizes the result thereof. By doing so, the user of the information processing apparatus 2000 can easily recognize the sales predicted for the future.

It should be noted that, as described above, for example, it is assumed that the user of the information processing apparatus 2000 can specify a boundary date and time which is the boundary between the first partial period and the second partial period. In this case, it is desirable that the information processing apparatus 2000 decides the prediction model in response to specifying the boundary date and time from the user and displays the sales predicted by the decided prediction model on the display screen 10. By doing so, the user changes the boundary date and time, and thus, the prediction model to be selected is changed. As a result, the predicted sales displayed on the display screen 10 is changed. Thus, for example, the user may select an appropriate prediction model by a method of “changing the boundary date and time while visually determining whether or not the prediction result displayed on the display screen 10 is appropriate until the prediction result considered as being appropriate is displayed”.

### Example Embodiment 2

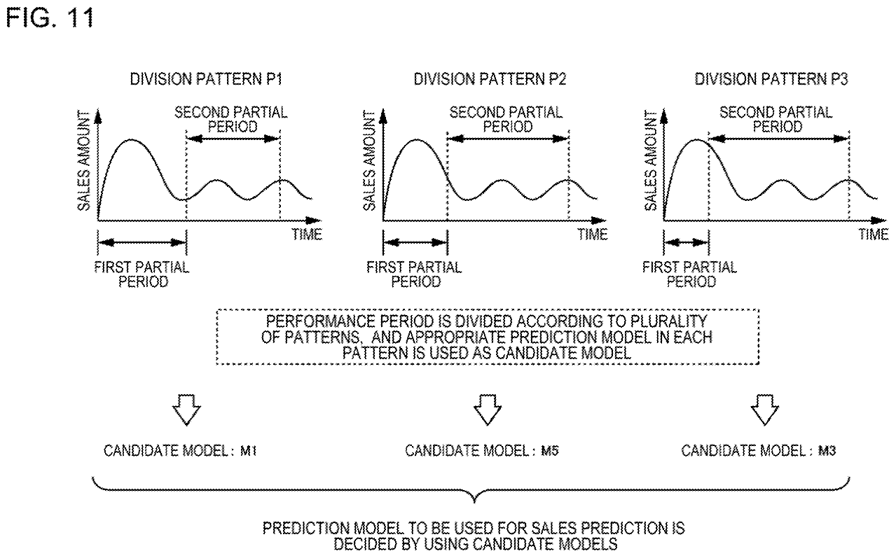

FIG. 11 is a diagram illustrating an operation of an information processing apparatus 2000 according to Example Embodiment 2. The operation of the information processing apparatus 2000 to be described below is an example for facilitating the understanding of the information processing apparatus 2000, and the operation of the information processing apparatus 2000 is not limited to the following example. The information processing apparatus 2000 according to Example Embodiment 2 has the same functions as those of the information processing apparatus 2000 according to Example Embodiment 1 except for the points to be described below.

The information processing apparatus 2000 according to Example Embodiment 2 divides the performance period with a plurality of patterns (hereinafter, referred to as division patterns), and decides the prediction model suitable for each division pattern. Here, the length of the first partial period is different in each division pattern. In FIG. 11, the information processing apparatus 2000 divides the performance period with three division patterns P1 to P3.

The information processing apparatus 2000 decides the prediction model (the prediction model in which the degree of deviation between the prediction data and the performance data is minimized) appropriate for the sales prediction for each of the three division patterns by the method described in Example Embodiment 1. Here, the prediction model decided as the prediction model appropriate for the sales prediction in a certain division pattern is referred to as a candidate model. The candidate model decided for a certain division pattern is referred to as a “candidate model corresponding to the division pattern”. The candidate model corresponding to the certain division pattern is decided as the prediction model to be used for the sales prediction in a case where the performance period is divided with the division pattern in the information processing apparatus 2000 according to Example Embodiment 1.

In an example of FIG. 11, it is assumed that the information processing apparatus 2000 acquires five prediction models M1 to M5. First, the information processing apparatus 2000 divides the performance period with the division pattern P1, and performs the prediction using the five prediction models for the second partial period in the division pattern P1. Subsequently, the information processing apparatus 2000 decides the candidate model corresponding to the division pattern P1 by comparing the prediction data obtained for each prediction model with the performance data. In the example of FIG. 11, the candidate model corresponding to the division pattern P1 is the prediction model M1.

The information processing apparatus 2000 performs the same processing for the division patterns P2 and P3. By doing so, the prediction models M5 and M3 are decided as the candidate models corresponding to the division patterns P2 and P3, respectively.

The information processing apparatus 2000 decides, as the prediction model to be used for the sales prediction after the performance period, one of the three candidate models M1, M3, and M5.

<Actions and Effects>

In accordance with the information processing apparatus 2000 according to the present example embodiment, the prediction model to be used for the sales prediction is decided by dividing the performance period with the plurality of patterns in which the lengths of the first partial periods are different and further comparing the prediction model selected for each pattern. Thus, even in a case where it is difficult to recognize the appropriate length of the first partial period in advance (for example, in a case where it is not possible to accurately determine which part of the performance data corresponds to the special sales tendency), a highly accurate prediction model can be selected.

<Example of Functional Configuration of Information Processing Apparatus 2000>

For example, the functional configuration of the information processing apparatus 2000 according to Example Embodiment 2 is represented in FIG. 3 as in the information processing apparatus 2000 according to Example Embodiment 1. The dividing unit 2020 according to Example Embodiment 2 divides the performance period with the plurality of division patterns. The comparing unit 2040 performs the prediction processing on each of the plurality of prediction models for each of the plurality of division patterns for the second partial period in the division pattern. The comparing unit 2040 compares the result of the prediction processing with the performance data in the second partial period in this pattern.

The first deciding unit 2060 according to Example Embodiment 2 decides, for each division pattern, the prediction model (the prediction model corresponding to the division pattern) appropriate for the division pattern from the result of the comparison performed by the comparing unit 2040 on the division pattern. For example, in the example of FIG. 11, the prediction model M1, the prediction model M5, and the prediction model M3 are decided as the prediction models corresponding to the division patterns P1, P2, and P3, respectively. The first deciding unit 2060 decides the prediction model to be used for the sales prediction by using the respective prediction models corresponding to the plurality of division patterns. For example, in the example of FIG. 11, the prediction model to be used for the sales prediction is decided among the prediction models M1, M3, and M5. However, as will be described below, the method of deciding the prediction model to be used for the sales prediction is not limited to a method of selecting one from the candidate models.

<Flow of Process>

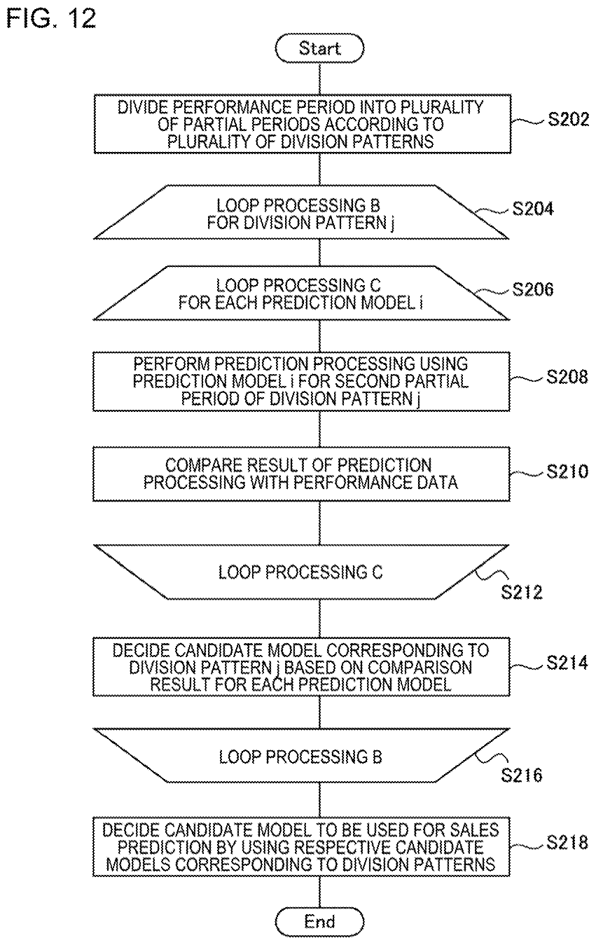

FIG. 12 is a flowchart illustrating a flow of a process executed by the information processing apparatus 2000 according to Example Embodiment 2. The dividing unit 2020 divides the performance period into the plurality of partial periods with the plurality of division patterns (S202). S204 to S216 are loop processing B executed for each of the plurality of division patterns. In S204, the information processing apparatus 2000 judges whether or not the loop processing B is already executed on all the division patterns. In a case where the loop processing B is already executed on all the division patterns, the processing of FIG. 12 proceeds to S218. On the other hand, in a case where there are the division patterns on which the loop processing B is not performed yet, the information processing apparatus 2000 executes the loop processing B on one of these division patterns. Here, the division pattern on which the loop processing B is to be performed is referred to as a division pattern j.

Steps S206 to S212 are loop processing C executed for each of the plurality of prediction models. The execution of the loop processing C is equivalent to the execution of the loop processing A of FIG. 5 for the performance period divided according to the division pattern j. In S206, the information processing apparatus 2000 judges whether or not the loop processing C is already executed on all the prediction models. In a case where the loop processing C is already executed on all the prediction models, the process of FIG. 12 proceeds to S214. On the other hand, in a case where there are the prediction models on which the loop processing C is not performed yet, the information processing apparatus 2000 executes the loop processing C on one of these prediction models. Here, the prediction model on which the loop processing C is performed is referred to as a prediction model i.

The comparing unit 2040 performs the prediction processing using the prediction model i for the second partial period of the division pattern j (S208). The comparing unit 2040 compares the prediction data obtained in the prediction processing with the performance data (S210). Since S212 is the end of the loop processing C, the process of FIG. 12 proceeds to S206.

After the loop processing C is completed, the first deciding unit 2060 decides the candidate model corresponding to the division pattern j on the basis of the comparison result of the prediction result of each prediction model with the performance data (S214). Since S216 is the end of the loop processing B, the process of FIG. 12 proceeds to S204.

After the loop processing B is completed, the first deciding unit 2060 decides the prediction model to be used for the sales prediction by using the candidate model corresponding to each division pattern (S218).

<Method of Deciding Prediction Model to be Used for Sales Prediction: S218>

The first deciding unit 2060 decides the prediction model to be used for the sales prediction by using the candidate model corresponding to each division pattern (S218). Various methods can be adopted as a specific method thereof. Hereinafter, a plurality of specific methods will be illustrated.

<<Method 1>>

For example, the first deciding unit 2060 selects, as the prediction model to be used for the sales prediction, the prediction model having the largest number of corresponding division patterns from among the candidate models. That is, the first deciding unit 2060 decides, as the prediction model to be used for the sales prediction, the prediction model having the largest number of times this prediction model is decided as the candidate model (hereinafter, the number of times of candidates).

For example, it is assumed that the candidate models corresponding to the five division patterns P1 to P5 are the prediction models M1, M2, M3, M2, and M2. In this case, the number of times of candidates of the prediction model M2 is three, and is larger than the number of times of candidates of other prediction models. Thus, the first deciding unit 2060 decides the prediction model M2 as the prediction model to be used for the sales prediction.

<<Method 2>>

For example, a priority may be decided for each prediction model in advance. For example, in the table 200 of FIG. 7, the priority is associated with each prediction model in advance. In this case, the first deciding unit 2060 selects the candidate model having the highest priority from among the plurality of candidate models.

For example, it is assumed that the prediction models M1, M2, and M3 are decided as the candidate models corresponding to the three division patterns P1 to P3. It is assumed that the priorities of the prediction models M1 to M3 are 50, 30, and 60, respectively. In this case, since the candidate model having the highest priority is M3, the first deciding unit 2060 decides the prediction model M3 as the candidate model.

For example, the priority of the prediction model may be decided on the basis of, for example, the amount of performance data used for generating the prediction model or the evaluation (the degree of deviation between the prediction data generated by the prediction model and the performance data) of the prediction model at the business facility that already uses this prediction model.

<<Method 3>>

For example, the first deciding unit 2060 generates the prediction model to be used for the sales prediction by performing the statistical processing on the plurality of candidate models. This statistical processing is, for example, averaging.

Here, the first deciding unit 2060 may perform the statistical processing on the candidate model by using the number of times of candidates and the priority described above. For example, the first deciding unit 2060 generates the prediction model to be used for the sales prediction by performing the statistical processing on the candidate models having a predetermined rank or higher in descending order of the number of times of candidates or performing the statistical processing on the candidate models having a predetermined rank or higher in descending order of the magnitude of the priority. For example, the first deciding unit 2060 may generate the prediction model to be used for the sales prediction by assigning a weight which becomes larger as the number of times of candidates becomes larger and a weight which becomes larger as the priority becomes higher to the candidate model and computing a weighted average. For example, the number of times of candidates itself or a value obtained by normalizing the number of times of candidates may be used as the weight which becomes larger as the number of times of candidates becomes larger. Similarly, the priority itself or a value obtained by normalizing the priority may be used as the weight which becomes larger as the priority becomes higher.

<<Method 4>>

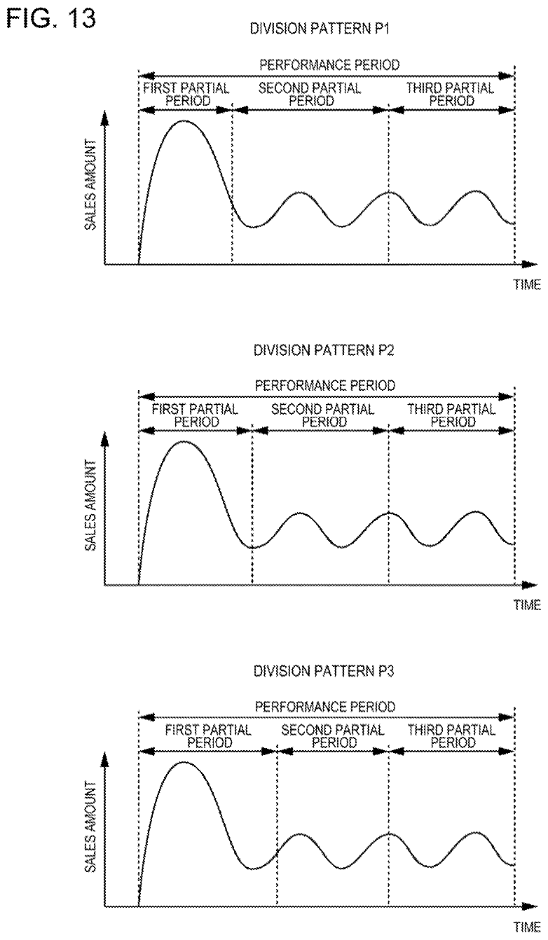

For example, the information processing apparatus 2000 divides the performance period into three partial periods: a first partial period, a second partial period, and a third partial period. FIG. 13 is a diagram illustrating a case where the performance period is divided into three partial periods. In each division pattern of FIG. 13, the end time of the second partial period is the same. In other words, the length of the third partial period is the same. In this case, the information processing apparatus 2000 generates the plurality of division patterns by changing the date and time as the boundary between the first partial period and the second partial period.

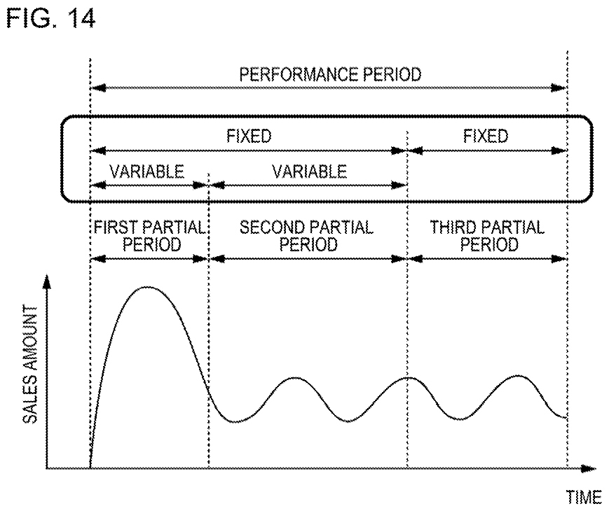

Here, the third partial period is common to all the division patterns. FIG. 14 is a diagram illustrating a relationship between the performance period and each partial period. The performance period is divided into the first partial period, the second partial period, and the third partial period. The third partial period is a fixed period. Thus, a combined period of the first partial period and the second partial period is also a fixed period. On the other hand, the first partial period and the second partial period are variable. That is, the plurality of division patterns is generated by changing the boundary between the first partial period and the second partial period.

There are various methods of deciding the length of the third partial period. For example, the length of the third partial period is decided as a predetermined value (for example, one week) in advance. For example, a percentage of the third partial period to the entire performance period may be decoded in advance (for example, 20%). That is, the length of the third partial period is decided according to the length of the performance period.

Here, it is assumed that the candidate model decided for the division pattern P1 is the prediction model M1. In this case, the first deciding unit 2060 executes the prediction processing using the prediction model M1 for the third partial period in the division pattern P1. The first deciding unit 2060 compares the prediction result with the performance data of the third partial period in the division pattern P1. Specifically, the first deciding unit 2060 computes the deviation index value between the prediction data obtained by the prediction processing for the third partial period in the division pattern P1 and the performance data in the third partial period. For another division pattern, similarly, the first deciding unit 2060 executes the prediction processing of the candidate model for the third partial period in the other division pattern, and computes the index value representing the degree of deviation between the prediction data obtained as the result and the performance data in the third partial period. That is, the deviation index value is obtained for each division pattern.

The first deciding unit 2060 decides the prediction model to be used for the sales prediction on the basis of the deviation index value obtained for each division pattern. For example, the first deciding unit 2060 sets, as the prediction model to be used for the sales prediction, the candidate model of each division pattern having the smallest computed deviation index value from among the respective candidate models of the division patterns.

According to this method, the prediction model to be used for the sales prediction is decided by dividing the performance period with the plurality of patterns of which the lengths of the first partial periods are different and comparing the prediction model selected for each pattern in the common third partial period. For example, in the case of the division pattern in which the first partial period is set to be extremely short, the second partial period includes the special sales tendency. Thus, since the selected prediction model performs the prediction reflecting the special sales tendency in the third partial period, the deviation from the performance becomes large. On the other hand, in the case of the pattern in which the first partial period is set to be extremely long, the period available as the second partial period becomes short, instead of including the special sales tendency in the second partial period. As the period becomes shorter, the prediction model in which the prediction is right on in only the short period is more likely to be selected. Thus, the deviation between the selected prediction model and the performance is increased in the third partial period. In the case of the division pattern in which the first partial period is set as the period showing the special sales tendency and the second partial period can be used to the maximum, the deviation between the selected prediction model and the performance becomes the smallest in the third partial period, and the prediction model is expected to be finally decided as the prediction model to be used. As stated above, according to the present method, the period corresponding to the special sales tendency is appropriately excluded, and thus, the prediction model selected in the division pattern in which limited data is used to the maximum can be selected.

As described above, the third partial period is common to the plurality of division patterns. Here, the performance data of the third partial period is data to be used for evaluating the candidate model. Thus, a case where the third partial period is common to the plurality of division patterns means that each candidate model is evaluated with the common sales performance. The candidate model can be evaluated with high accuracy by evaluating each candidate model on the basis of the common sales performance.

<Example of Hardware Configuration>

A hardware configuration of a computer that realizes the information processing apparatus 2000 according to Example Embodiment 2 is represented by, for example, FIG. 4 as in Example Embodiment 1. However, the storage device 1080 of the computer 1000 that realizes the information processing apparatus 2000 according to the present example embodiment further stores a program module that realizes the functions of the information processing apparatus 2000 according to the present example embodiment.

### Example Embodiment 3

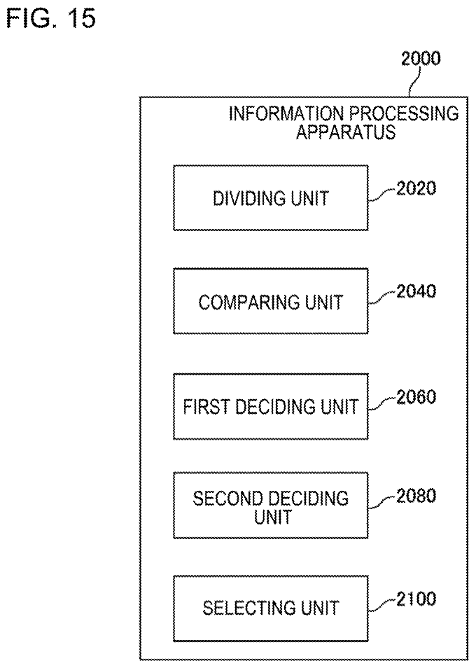

FIG. 15 is a diagram illustrating a functional configuration of an information processing apparatus 2000 according to Example Embodiment 3. The information processing apparatus 2000 according to Example Embodiment 3 has the same functions as those of the information processing apparatus 2000 according to Example Embodiment 1 or 2 except for the points to be described below.

The information processing apparatus 2000 according to Example Embodiment 3 includes a second deciding unit 2080. The second deciding unit 2080 decides the prediction model to be used for the sales prediction from among the prediction models already used for the sales prediction of the product or the like as the prediction target at the target business facility. That is, the prediction model used once is reused.

For example, the second deciding unit 2080 decides, as the prediction model to be used for the sales prediction, the prediction model most recently used for the sales prediction of the product or the like as the prediction target at the target business facility. That is, the same prediction model is continuously used. For example, the second deciding unit 2080 decides, as the prediction model to be used for the sales prediction, the prediction model most frequently used during a predetermined period (for example, the latest one month). Here, information regarding the prediction model used for each product or the like at the target business facility, that is, the usage history of the prediction model is stored in, for example, a storage device accessible from the information processing apparatus 2000.

The information processing apparatus 2000 according to Example Embodiment 3 further includes a selecting unit 2100. The selecting unit 2100 causes one of the first deciding unit 2060 and the second deciding unit 2080 to decide the prediction model to be used at the business facility as the prediction target. Specifically, in a case where a certain predetermined condition (hereinafter, a first predetermined condition) is satisfied, the selecting unit 2100 causes the first deciding unit 2060 to decide the prediction model. On the other hand, in a case where the first predetermined condition is not satisfied, the selecting unit 2100 causes the second deciding unit 2080 to decide the prediction model.

### Advantageous Effects

According to the method of deciding the prediction model by using the second deciding unit 2080, since the prediction model already used at the target business facility is reused, it is necessary to perform the process for generating the prediction data by using the prediction model and the process for comparing the prediction data with the performance data, unlike a case where the first deciding unit 2060 is used. Thus, a time required to decide the prediction model is short, and the amount of computer resources required to decide the prediction model is small.

On the other hand, according to the method of deciding the prediction model by using the first deciding unit 2060, since an appropriate prediction model is selected from among the plurality of prediction models by using the performance data, it is possible to select a relatively high accurate prediction model.

Therefore, the information processing apparatus 2000 according to Example Embodiment 3 appropriately uses two methods of which features are different, as the method of deciding the prediction model. By doing so, it is possible to shorten the time required for deciding the prediction model and reduce the amount of computer resources required for deciding the prediction model while increasing the accuracy of the prediction model.

Some users who use the prediction models acquire experience of sales tendencies by interpreting the contents of the prediction models (for example, the adopted variables and the values of the weights). In this case, in a case where the prediction model is frequently updated, the user needs to frequently interpret the prediction model.

The information processing apparatus 2000 according to the present example embodiment allows the frequency at which the prediction model is replaced with a new prediction model to be reduced by using not only the first deciding unit 2060 but also the second deciding unit 2080. Thus, the burden of the user who interprets the prediction model can be reduced.

<Flow of Process>

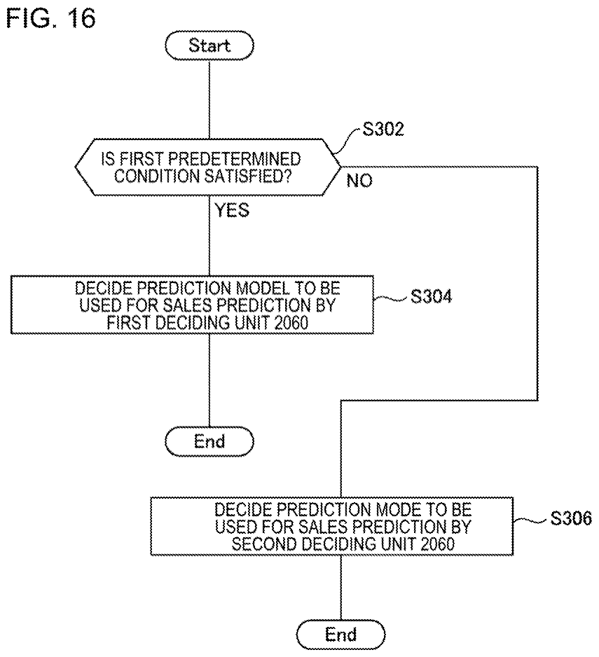

FIG. 16 is a flowchart illustrating a flow of a process executed by the information processing apparatus 2000 according to Example Embodiment 3. The selecting unit 2100 judges whether the first predetermined condition is satisfied (S302). In a case where the first predetermined condition is satisfied (S302: YES), the decision of the prediction model is performed by using the first deciding unit 2060 (S304). For example, the series of processing illustrated in the flowcharts of FIGS. 5 and 12 are executed.

On the other hand, in a case where the first predetermined condition is not satisfied (S302: NO), the decision of the prediction model is performed by using the second deciding unit 2080 (S306).

<About First Predetermined Condition>

Various conditions can be adopted as the first predetermined condition. Hereinafter, the first predetermined condition will be illustrated.

<<Example 1 of First Predetermined Condition>>>

It is assumed that the information processing apparatus 2000 decides the prediction model at a predetermined cycle. As a specific example, there is a case where the information processing apparatus 2000 is operated once a day before the business facility starts business to decide the prediction model to be used for the sales prediction for the day. In this case, for example, an operation in which the first deciding unit 2060 is used at a predetermined frequency (for example, once every predetermined number of times) and the second deciding unit 2080 is used in other cases (the already used prediction model is reused) is considered.

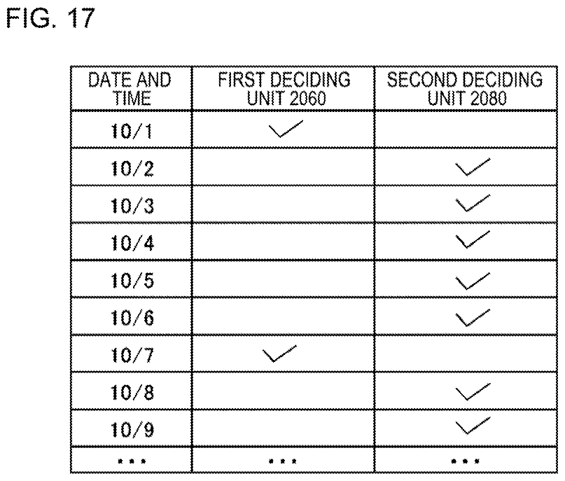

Therefore, in this case, for example, the first predetermined condition may be a condition of “a predetermined time elapses since the first deciding unit 2060 is used last” or “the second deciding unit 2080 is continuously used a predetermined number of times”. FIG. 17 is a diagram illustrating a table in which the first deciding unit 2060 is used at a predetermined frequency. This table represents a check mark for one of the first deciding unit 2060 and the second deciding unit 2080 to be used for deciding the prediction model. This table represents that the first deciding unit 2060 is used once every seven times (that is, once a week).

<<Example 2 of First Predetermined Condition>>

The selecting unit 2100 may select the first deciding unit 2060 in a case where the accuracy of the currently used prediction model is decreased, and may select the second deciding unit 2080 in other cases. For example, the selecting unit 2100 computes the deviation index value between the prediction data obtained by the currently used prediction model and the sales performance data for a past predetermined period (for example, the previous day or the latest one week), and selects any one of the first deciding unit 2060 and the second deciding unit 2080 on the basis of the deviation index value. It should be noted that, the deviation index value is as described above.

In a case where the degree of deviation between the prediction data and the sales performance data is small, since the accuracy of the currently used prediction model is sufficient, it is considered that there is no problem even though the prediction model is continuously used. On the other hand, in a case where the degree of deviation between the prediction data and the sales performance data is large, since the accuracy of the prediction model is decreased, it is considered that the prediction model needs to be replaced.

Therefore, for example, a condition of “the deviation index value computed for the prediction data and the performance data in the past predetermined period is equal to or greater than a predetermined value” is used as the first predetermined condition. Accordingly, in a case where the deviation index value is equal to or greater than the predetermined value, the prediction model to be used for the sales prediction is decided by using the performance data and using the plurality of prediction models by the method described in Example Embodiments 1 and 2. On the other hand, in a case where the deviation index value is less than the predetermined value, the prediction model to be used for the sales prediction is decided among the already used prediction models. It should be noted that, the predetermined value may be fixedly set in advance, or may be specified by the user of the information processing apparatus 2000.

<Example of Hardware Configuration>

A hardware configuration of a computer that realizes the information processing apparatus 2000 according to Example Embodiment 3 is represented by, for example, FIG. 4 as in Example Embodiment 1. However, the storage device 1080 of the computer 1000 that realizes the information processing apparatus 2000 according to the present example embodiment further stores a program module that realizes the functions of the information processing apparatus 2000 according to the present example embodiment.

### Example Embodiment 4

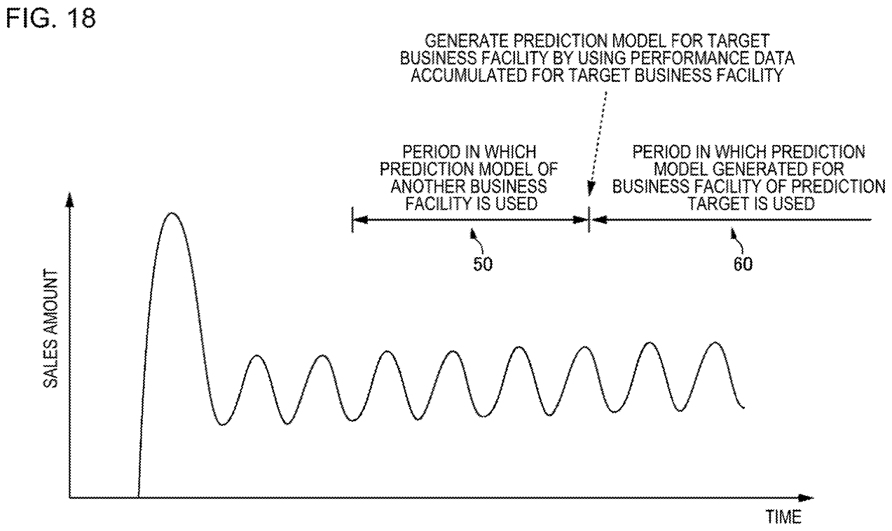

FIG. 18 is a diagram illustrating an operation of the information processing apparatus 2000 according to Example Embodiment 4. In the information processing apparatus 2000 according to Example Embodiments 1 to 3, the prediction model generated for another business facility is used in order to predict sales at the target business facility (for example, a newly opened store). However, as the performance data is accumulated at the target business facility, it is possible to generate the prediction model that accurately represents the sales tendency of the business facility by using the performance data of the business facility.

Therefore, the information processing apparatus 2000 generates the prediction model by using the performance data of the product or the like as the prediction target at the target business facility. The information processing apparatus 2000 judges whether or not the performance data of the product or the like as the prediction target at the target business facility satisfies a second predetermined condition. In a case where the second predetermined condition is satisfied, the information processing apparatus 2000 decides the generated prediction model as the prediction model to be used for the sales prediction of the product or the like as the prediction target at the target business facility.

For example, in FIG. 18, the prediction model generated for another business facility is used in a period 50. That is, the information processing apparatus 2000 decides the prediction model by the method described in any of Example Embodiments 1 to 3. On the other hand, the prediction model generated for the target business facility is used in a period 60. It should be noted that, the method of generating the prediction model from the performance data is as described above.

<Actions and Effects>

In a case where the necessity of using the prediction model of another business facility is decreased such as a case where the accuracy of the prediction model generated for the target business facility is sufficiently high, it is desirable that the sales prediction is performed by using the prediction model generated for the target business facility. The information processing apparatus 2000 according to the present example embodiment allows, in a case where the performance data of the target business facility satisfies the predetermined condition, the prediction model generated for the target business facility to be used for the sales prediction of the target business facility. Thus, after it becomes possible to generate the highly accurate prediction model by using the performance data of the target business facility, the process for selecting the prediction model becomes unnecessary, and thus, it is possible to reduce the amount of computer resources while predicting the sales by the highly accurate prediction model.

<Example of Functional Configuration of Information Processing Apparatus 2000>

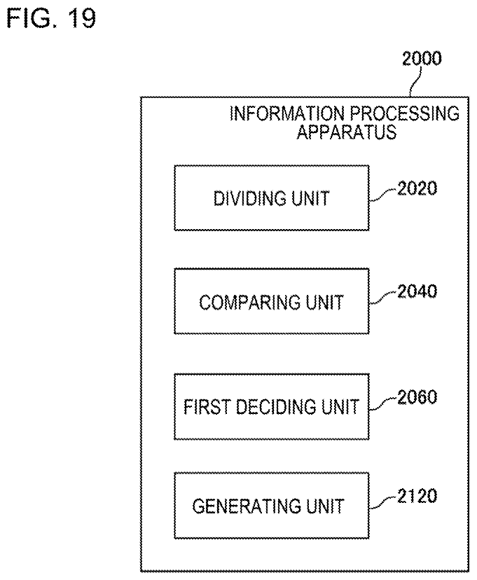

FIG. 19 is a diagram illustrating a functional configuration of the information processing apparatus 2000 according to Example Embodiment 4. The information processing apparatus 2000 according to Example Embodiment 4 includes a generating unit 2120. The generating unit 2120 generates the prediction model for predicting the sales of the product or the like as the prediction target by using the performance data of the product or the like at the target business facility. In a case where the performance data at the target business facility satisfies the second predetermined condition, the information processing apparatus 2000 according to Example Embodiment 4 decides, as the prediction model to be used for the sales prediction, the prediction model generated by the generating unit 2120.

<Flow of Process>

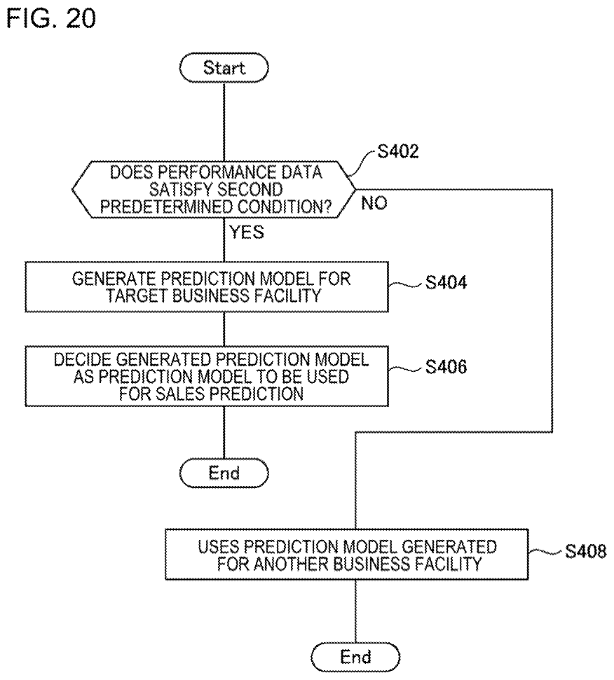

FIG. 20 is a flowchart illustrating a flow of a process executed by the information processing apparatus 2000 according to Example Embodiment 4. In a case where the performance data of the target business facility satisfies the second predetermined condition (S402: YES), the generating unit 2120 generates the prediction model for predicting the sales of the product or the like as the prediction target by using the performance data of the product or the like at the target business facility (S404). The first deciding unit 2060 decides the prediction model generated in S404 as the prediction model to be used for the sales prediction of the product or the like as the prediction target (S406). On the other hand, in a case where the performance data at the target business facility does not satisfy the second predetermined condition (S402: NO), the information processing apparatus 2000 decides the prediction model to be used for the sales prediction of the business facility as the prediction target by using the prediction model generated by using the performance data of another business facility (S408). In S408, the prediction model is decided by any of the methods described in Example Embodiments 1 to 3.

<About Second Predetermined Condition>

The second predetermined condition is a condition satisfied in a case where the accuracy of the prediction model generated by using the performance data of the target business facility is high. For example, the second predetermined condition is a case where the period of the sales performance indicated by the performance data of the target business facility is equal to or longer than a predetermined length. Here, in a case where the information processing apparatus 2000 decides the prediction model to be used for the sales prediction at the newly opened business facility, the period of the sales performance is a period since the business facility being opened. For example, in a case where the information processing apparatus 2000 decides the prediction model to be used for the sales prediction of the newly-released product, the period of the aforementioned sales performance is a period since the newly-released product being started to be sold at the store as the prediction target. For example, in a case where the information processing apparatus 2000 decides the prediction model to be used for the sales prediction after the sales tendency is changed, the period of the sales performance is a period from a time when the sales tendency is changed.

<Example of Hardware Configuration>

A hardware configuration of a computer that realizes the information processing apparatus 2000 according to Example Embodiment 4 is represented by, for example, FIG. 4 as in Example Embodiment 1. However, the storage device 1080 of the computer 1000 that realizes the information processing apparatus 2000 according to the present example embodiment further stores a program module that implements the functions of the information processing apparatus 2000 according to the present example embodiment.

### Other Example Embodiments

As mentioned above, although the example embodiments of the present invention have been described with reference to the drawings, these example embodiments are merely examples of the present invention, and may adopt a configuration in which the aforementioned example embodiments are combined or various other configurations.

For example, in each of the aforementioned example embodiments, the information processing apparatus 2000 predicts the sales of the products or the like. However, the information processing apparatus 2000 may be configured to predict the number of customers at the business facility by using the same method.

In this case, the information processing apparatus 2000 uses performance data representing performance of the number of customers instead of the performance data representing the performance of the sales. The information processing apparatus 2000 uses, as the prediction model, the prediction model for predicting the number of customers. Variables to be used in the prediction model for predicting the number of customers include, for example, the number of customers in the latest predetermined period of the prediction target day, the weathers of the prediction target date and the predetermined periods before and after the prediction target date, and the attributes of the prediction target date and the predetermined periods before and after the prediction target date.

The customers as the prediction target are, for example, all customers who visit the business facility. For example, the customer as the prediction target may be a customer having a specific attribute among customers who visit the business facility. For example, the customers are classified into a plurality of categories based on attributes such as gender and age group, and customer prediction is performed predicted for each of the categories.

The business facility which is a target of the customer prediction may be, for example, the same as the target of the sales prediction. The target of the customer prediction may be various facilities where services are mainly provided such as restaurants, stadiums, museums, and theme parks.

Here, there are cases where the inside of the large-scale business facility is divided into the plurality of sections. In this case, the customer prediction may be performed for each of the plurality of sections, or the customer prediction may be performed for the entire business facility.

For example, the following scene is considered as a scene in which the information processing apparatus 2000 is used in a case where the number of customers is predicted. For example, the information processing apparatus 2000 is used to decide the prediction model to be used for predicting the customers of the business facility where business is newly started. In this case, the start time of the performance period is a date on which the business of the business facility is started.

For example, in a case where a new service is started to be provided at the target business facility, the information processing apparatus 2000 is used to decide the prediction model for predicting the number of customers who will receive the new service. In this case, the start time of the performance period is, for example, a date on which the service is started to be provided.

For example, the information processing apparatus 2000 decides the prediction model by using, as the target business facility, the business facility where the prediction model to be used for the customer prediction needs to be changed due to a significant change in the number of customers. Specifically, some time after the tendency of the number of customers is changed at the target business facility, the information processing apparatus 2000 decides the prediction model to be newly used at the target business facility by using the performance data representing the number of customers after the tendency of the customers is changed. In this case, the start time of the performance period is, for example, a date on which the sales tendency of the number of customers is changed at the target business facility. This date may be specified by the user, or may be decided by the information processing apparatus 2000 by performing the statistical processing on the performance data.

A part or all of the aforementioned example embodiments may be described as in the following appendix, but is not limited thereto.

1. An information processing apparatus including:

a dividing unit that divides a performance period in which performance data at a business facility as a prediction target is present into a plurality of partial periods;

a comparing unit that performs prediction processing using each of a plurality of prediction models for a second partial period which is a partial period other than a first partial period including a start time of the performance period, and compares the result of the process with the performance data in a partial period as a target of the prediction processing; and

a first deciding unit that decides a prediction model to be used for sales prediction of a period subsequent to the performance period on the basis of the result of the comparison performed by the comparing unit.

2. An information processing apparatus including:

a dividing unit that divides a performance period in which performance data at a business facility as a prediction target is present into a plurality of partial periods;

a comparing unit that performs prediction processing using each of a plurality of prediction models for a second partial period which is a partial period other than a first partial period including a start time of the performance period, and compares the result of the process with the performance data in a partial period as a target of the prediction processing; and

a first deciding unit that decides a prediction model to be used for customer prediction of a period subsequent to the performance period on the basis of the result of the comparison performed by the comparing unit.

3. The information processing apparatus according to 1 or 2,

in which for each of the prediction models, the comparing unit computes a degree of deviation between prediction data of sales generated in the prediction processing of the prediction model for the second partial period and the performance data in the second partial period, and

the first deciding unit decides the prediction model to be used for the prediction in the period subsequent to the performance period on the basis of the computed degrees of deviation.

4. The information processing apparatus according to any one of 1 to 3,

in which the start time of the performance period is any one of a date on which business is newly started, a date on which a specific product is started to be sold, and a date on which a specific service is started to be provided.

5. The information processing apparatus according to any one of 1 to 4,

in which the dividing unit divides the performance period with a plurality of patterns of which lengths of the first partial periods are different,

for each of the plurality of patterns, the comparing unit performs the prediction processing using each of the plurality of prediction models for the second partial period in the pattern and compares the result of the prediction processing with the performance data in the second partial period in the pattern, and

the first deciding unit decides, for each of the patterns, the prediction model corresponding to the pattern from the result of the comparison performed for the pattern by the comparing unit, and decides the prediction model to be used for the prediction in the period subsequent to the performance period by using the prediction model corresponding to each of the plurality of patterns.

6. The information processing apparatus according to 5,

in which the dividing unit divides the performance period into three of the first partial period, the second partial period, and a third partial period in each of the plurality of patterns,

the third partial period is a period common to the plurality of patterns, and

the first deciding unit

generates, for each of the plurality of patterns, prediction data of the third partial period in the pattern by using the prediction model corresponding to the pattern and computes a degree of deviation between the generated prediction data and the performance data in the third partial period in the pattern, and

decides the prediction model to be used for the prediction in the period subsequent to the performance period on the basis of the computed degrees of deviation.

7. The information processing apparatus according to any one of 1 to 6 further including:

a second deciding unit that decides the prediction model to be used for the sales prediction in the period subsequent to the performance period from among the prediction models already used for the prediction target; and

a selecting unit that causes any one of the first deciding unit and the second deciding unit to decide the prediction model to be used for the sales prediction in the period subsequent to the performance period.

8. The information processing apparatus according to any one of 1 to 7 further including:

a generating unit that generates the prediction model by using the performance data,

in which the first deciding unit decides the generated prediction model as the prediction model to be used for the prediction target in a case where the performance data satisfies a second performance condition.

9. The information processing apparatus according to any one of 1 to 8,

in which the prediction model used by the comparing unit is generated by using performance at a business facility different from the business facility as the prediction target.

10. A program causing a computer to execute:

a dividing step of dividing a performance period in which performance data at a business facility as a prediction target is present into a plurality of partial periods;

a comparing step of performing prediction processing using each of a plurality of prediction models for a second partial period which is a partial period other than a first partial period including a start time of the performance period, and comparing the result of the process with the performance data in a partial period as a target of the prediction processing; and

a first deciding step of deciding a prediction model to be used for sales prediction of a period subsequent to the performance period on the basis of the result of the comparison performed in the comparing step.

11. A program causing a computer to execute:

a dividing step of dividing a performance period in which performance data at a business facility as a prediction target is present into a plurality of partial periods;

a comparing step of performing prediction processing using each of a plurality of prediction models for a second partial period which is a partial period other than a first partial period including a start time of the performance period, and comparing the result of the process with the performance data in a partial period as a target of the prediction processing; and

a first deciding step of deciding a prediction model to be used for customer prediction of a period subsequent to the performance period on the basis of the result of the comparison performed in the comparing step.

12. The program according to 10 or 11,

in which, in the comparing step, a degree of deviation between prediction data of sales generated in the prediction processing of the prediction model for the second partial period and the performance data in the second partial period is computed for each of the prediction models, and

in the first deciding step, the prediction model to be used for the prediction in the period subsequent to the performance period is decided on the basis of the computed degree of deviation.

13. The program according to any one of 10 to 12,

in which the start time of the performance period is any one of a date on which business is newly started, a date on which a specific product is started to be sold, and a date on which a specific service is started to be provided.

14. The program according to any one of 10 to 13,

in which in the dividing step, the performance period is divided with a plurality of patterns of which lengths of the first partial periods are different,

in the comparing step, for each of the plurality of patterns, the prediction processing using each of the plurality of prediction models is performed for the second partial period in the pattern and the result of the prediction processing is compared with the performance data in the second partial period in the pattern, and

in the first deciding step, for each of the patterns, the prediction model corresponding to the pattern is decided from the result of the comparison performed for the pattern in the comparing step, and the prediction model to be used for the prediction in the period subsequent to the performance period is decided by using the prediction model corresponding to each of the plurality of patterns.

15. The program according to 14,

in which in the dividing step, the performance period is divided into three of the first partial period, the second partial period, and a third partial period in each of the plurality of patterns,

the third partial period is a period common to the plurality of patterns, and

in the first deciding step,

for each of the plurality of patterns, prediction data of the third partial period in the pattern is generated by using the prediction model corresponding to the pattern and a degree of deviation between the generated prediction data and the performance data in the third partial period in the pattern is computed, and

the prediction model to be used for the prediction in the period subsequent to the performance period is decided on the basis of the computed degree of deviation.

16. The program according to any one of 10 to 15, the program causing the computer to further execute:

a second deciding step of deciding the prediction model to be used for the sales prediction in the period subsequent to the performance period from among the prediction models already used for the prediction target; and

a selecting step of deciding the prediction model to be used for the sales prediction in the period subsequent to the performance period in any one of the first deciding step and the second deciding step.

17. The program according to any one of 10 to 16, the program causing the computer to further execute:

a generating step of generating the prediction model by using the performance data,

in which in the first deciding step, the generated prediction model is decided as the prediction model to be used for the prediction target in a case where the performance data satisfies a second performance condition.

18. The program according to any one of 10 to 17,

in which the prediction model used in the comparing step is generated by using performance at a business facility different from the business facility as the prediction target.

19. A control method executed by a computer, the method including:

a dividing step of dividing a performance period in which performance data at a business facility as a prediction target is present into a plurality of partial periods;

a comparing step of performing prediction processing using each of a plurality of prediction models for a second partial period which is a partial period other than a first partial period including a start time of the performance period, and comparing the result of the process with the performance data in a partial period as a target of the prediction processing; and

a first deciding step of deciding a prediction model to be used for sales prediction of a period subsequent to the performance period on the basis of the result of the comparison performed in the comparing step.

20. A control method executed by a computer, the method including:

a dividing step of dividing a performance period in which performance data at a business facility as a prediction target is present into a plurality of partial periods;

a comparing step of performing prediction processing using each of a plurality of prediction models for a second partial period which is a partial period other than a first partial period including a start time of the performance period, and comparing the result of the process with the performance data in a partial period as a target of the prediction processing; and

a first deciding step of deciding a prediction model to be used for customer prediction of a period subsequent to the performance period on the basis of the result of the comparison performed in the comparing step.

21. The control method according to 19 or 20,

in which in the comparing step, for each of the prediction models, a degree of deviation between prediction data of sales generated in the prediction processing of the prediction model for the second partial period and the performance data in the second partial period is computed, and

in the first deciding step, the prediction model to be used for the prediction in the period subsequent to the performance period is decided on the basis of the computed degree of deviation.

22. The control method according to any one of 19 to 21,

in which the start time of the performance period is any one of a date on which business is newly started, a date on which a specific product is started to be sold, and a date on which a specific service is started to be provided.

23. The control method according to any one of 19 to 22,

in which in the dividing step, the performance period is divided with a plurality of patterns of which lengths of the first partial periods are different,

in the comparing step, for each of the plurality of patterns, the prediction processing using each of the plurality of prediction models is performed for the second partial period in the pattern and the result of the prediction processing is compared with the performance data in the second partial period in the pattern, and

in the first deciding step, for each of the patterns, the prediction model corresponding to the pattern is decided from the result of the comparison performed for the pattern in the comparing step, and the prediction model to be used for the prediction in the period subsequent to the performance period is decided by using the prediction model corresponding to each of the plurality of patterns.

24. The control method according to 23,

in which in the dividing step, the performance period is divided into three of the first partial period, the second partial period, and a third partial period in each of the plurality of patterns,

the third partial period is a period common to the plurality of patterns, and

in the first deciding step,

for each of the plurality of patterns, prediction data of the third partial period in the pattern is generated by using the prediction model corresponding to the pattern and a degree of deviation between the generated prediction data and the performance data in the third partial period in the pattern is computed, and

the prediction model to be used for the prediction in the period subsequent to the performance period is decided on the basis of the computed degree of deviation.

25. The control method according to any one of 19 to 24, further including:

a second deciding step of deciding the prediction model to be used for the sales prediction in the period subsequent to the performance period from among the prediction models already used for the prediction target; and

a selecting step of deciding the prediction model to be used for the sales prediction in the period subsequent to the performance period in any one of the first deciding step and the second deciding step.

26. The control method according to any one of 19 to 25, further including:

a generating step of generating the prediction model by using the performance data,

in which in the first deciding step, the generated prediction model is decided as the prediction model to be used for the prediction target in a case where the performance data satisfies a second performance condition.

27. The control method according to any one of 19 to 26,

in which the prediction model used in the comparing step is generated by using performance at a business facility different from the business facility as the prediction target.

This application claims the priority based on Japanese Patent Application No. 2017-190306 filed on Sep. 29, 2017, the disclosure of which is incorporated herein in its entirety.

1. An information processing apparatus comprising:
a dividing unit that divides a performance period in which performance data at a business facility as a prediction target is present into a plurality of partial periods;
a comparing unit that performs prediction processing using each of a plurality of prediction models for a second partial period which is a partial period other than a first partial period including a start time of the performance period, and compares the result of the process with the performance data in a partial period as a target of the prediction processing; and
a first deciding unit that decides a prediction model to be used for sales prediction of a period subsequent to the performance period on the basis of the result of the comparison performed by the comparing unit.

2. (canceled)

3. The information processing apparatus according to claim 1,
wherein for each of the prediction models, the comparing unit computes a degree of deviation between prediction data of sales generated in the prediction processing of the prediction model for the second partial period and the performance data in the second partial period, and
the first deciding unit decides the prediction model to be used for the prediction in the period subsequent to the performance period on the basis of the computed degrees of deviation.

4. The information processing apparatus according to claim 1,
wherein the start time of the performance period is any one of a date on which business is newly started, a date on which a specific product is started to be sold, and a date on which a specific service is started to be provided.

5. The information processing apparatus according to claim 1,
wherein the dividing unit divides the performance period with a plurality of patterns of which lengths of the first partial periods are different,
for each of the plurality of patterns, the comparing unit performs the prediction processing using each of the plurality of prediction models for the second partial period in the pattern and compares the result of the prediction processing with the performance data in the second partial period in the pattern, and
the first deciding unit decides, for each of the patterns, the prediction model corresponding to the pattern from the result of the comparison performed for the pattern by the comparing unit, and decides the prediction model to be used for the prediction in the period subsequent to the performance period by using the respective prediction models corresponding to the plurality of patterns.

6. The information processing apparatus according to claim 5,
wherein the dividing unit divides the performance period into three of the first partial period, the second partial period, and a third partial period in each of the plurality of patterns,
the third partial period is a period common to the plurality of patterns, and
the first deciding unit
generates, for each of the plurality of patterns, prediction data of the third partial period in the pattern by using the prediction model corresponding to the pattern and computes a degree of deviation between the generated prediction data and the performance data in the third partial period in the pattern, and
decides the prediction model to be used for the prediction in the period subsequent to the performance period on the basis of the computed degrees of deviation.

7. The information processing apparatus according to claim 1, further comprising:
a second deciding unit that decides the prediction model to be used for the sales prediction in the period subsequent to the performance period from among the prediction models already used for the prediction target; and
a selecting unit that causes any one of the first deciding unit and the second deciding unit to decide the prediction model to be used for the sales prediction in the period subsequent to the performance period.

8. The information processing apparatus according to claim 1, further comprising:
a generating unit that generates the prediction model by using the performance data,
wherein the first deciding unit decides the generated prediction model as the prediction model to be used for the prediction target in a case where the performance data satisfies a second performance condition.

9. The information processing apparatus according to claim 1,
wherein the prediction model used by the comparing unit is generated by using performance at a business facility different from the business facility as the prediction target.

10. A non-transitory computer-readable medium storing a program causing a computer to execute:
a dividing step of dividing a performance period in which performance data at a business facility as a prediction target is present into a plurality of partial periods;
a comparing step of performing prediction processing using each of a plurality of prediction models for a second partial period which is a partial period other than a first partial period including a start time of the performance period, and comparing the result of the process with the performance data in a partial period as a target of the prediction processing; and
a first deciding step of deciding a prediction model to be used for sales prediction of a period subsequent to the performance period on the basis of the result of the comparison performed in the comparing step.

11.-18. (canceled)

19. A control method executed by a computer, the method comprising:
dividing a performance period in which performance data at a business facility as a prediction target is present into a plurality of partial periods;
performing prediction processing using each of a plurality of prediction models for a second partial period which is a partial period other than a first partial period including a start time of the performance period, and comparing the result of the process with the performance data in a partial period as a target of the prediction processing; and
deciding a prediction model to be used for sales prediction of a period subsequent to the performance period on the basis of the result of the comparison.

20.-27. (canceled)
